(19) United States
(12) Patent Application Publication
(10) Pub. No.: US 2023/0356703 A1
(43) Pub. Date: Nov. 9, 2023

(54) BRAKING DEVICE FOR VEHICLE

(71) Applicant: ADVICS CO., LTD., Kariya-shi, Aichi-ken (JP)

(72) Inventor: Yasunori SAKATA, Kariya-shi, Aichi-ken (JP)

(73) Assignee: ADVICS CO., LTD., Kariya-shi, Aichi-ken (JP)

(21) Appl. No.: 17/802,172

(22) PCT Filed: Mar. 26, 2021
(86) PCT No.: PCT/JP2021/012882

§ 371 Date: Aug. 25, 2022

(30) Foreign Application Priority Data
Mar. 30, 2020 (JP) 2020-060797

(51) Int. Cl. B60T 13/14; B60T 17/22; B60T 13/68; B60T 13/62

(52) U.S. Cl. CPC B60T 13/148; B60T 13/142; B60T 17/22; B60T 13/686; B60T 13/62; B60T 2270/88; B60T 2270/402

(57) ABSTRACT

A vehicle braking device includes a first pressurizing unit including a cylinder, a piston slidable in the cylinder, an electric motor that drives the piston, and an output chamber partitioned by the cylinder and the piston. The first pressurizing unit is configured such that a connection state between the output chamber and a reservoir is switched between communication and cut-off states according to the piston position, and the first pressurizing unit is capable of pressurizing fluid by decreasing a volume of the output chamber by movement of the piston to one axial direction side; a pressure sensor that detects a pressure of the output chamber; and an estimation unit that executes a position estimation process of moving the piston and estimating a switching position of the piston at which the connection state of the output chamber and the reservoir is switched based on a detection value of the pressure sensor.

### TECHNICAL FIELD

The present disclosure relates to a vehicle braking device.

### BACKGROUND ART

Some braking devices for a vehicle include a hydraulic pressure generation device (e.g., an electric cylinder) that moves a piston by an electric motor to generate hydraulic pressure. In the electric cylinder, there may be an invalid stroke in which no hydraulic pressure is generated with respect to the driving of the electric motor due to the configuration. Here, for example, JP 5856021 B2 discloses a technique of setting a rotation angle of a motor related to an origin position serving as a starting point of generation of a hydraulic pressure in consideration of a return section.

### CITATION LIST

### Patent Literature

Patent Literature 1: JP 5856021 B2

### SUMMARY

### Technical Problems

However, in the vehicle braking device, the control is performed based on a fixed value (origin position information, return section information) related to the rotation angle of the electric motor, and there is a possibility that a deviation may occur between the control position based on the fixed value and the actual position of the piston due to, for example, an output error of the electric motor, an error of the linear motion mechanism, a detection error of the motor rotation angle sensor, or high and low of the outside air temperature.

An object of the present disclosure is to provide a vehicle braking device capable of accurately estimating a switching position of a piston at which a connection state between a pressurizing unit such as an electric cylinder and a reservoir is switched.

### Solutions to Problems

A vehicle braking device according to the present disclosure includes: a reservoir; a first pressurizing unit including a cylinder, a piston slidable in the cylinder, an electric motor that drives the piston, and an output chamber partitioned by the cylinder and the piston and whose volume changes by movement of the piston, the first pressurizing unit being configured such that a connection state between the output chamber and the reservoir is switched between a communication state and a cut-off state according to a position of the piston, and the first pressurizing unit being capable of pressurizing fluid by decreasing a volume of the output chamber by movement of the piston to one side in an axial direction; a pressure sensor that detects a pressure of the output chamber; and an estimation unit that executes a position estimation process of moving the piston and estimating a switching position of the piston at which the connection state of the output chamber and the reservoir is switched based on a detection value of the pressure sensor.

### Advantageous Effects

According to the present disclosure, when the output chamber and the reservoir are in the communication state, no hydraulic pressure is generated in the output chamber even if the piston is moved. On the other hand, when the output chamber and the reservoir are in the cut-off state, the hydraulic pressure in the output chamber changes according to the movement of the piston. At the time of pressurization, the detection value of the pressure sensor starts to rise from 0 (hydraulic pressure of the reservoir) when the piston 23 goes beyond the switching position. At the time of pressure reduction, the detection value of the pressure sensor becomes 0 when the piston goes beyond the switching position.

In the position estimation process, the estimation unit can estimate the switching position of the piston by monitoring the detection value of the pressure sensor while moving the piston and detecting the hydraulic pressure change of the output chamber as described above. Since the switching position of the piston is estimated based on the actual hydraulic pressure change, the switching position corresponding to the vehicle situation at the time of executing the position estimation process can be acquired. Thus, according to the present disclosure, the switching position of the piston at which the connection state between the output chamber and the reservoir is switched can be accurately estimated.

### BRIEF DESCRIPTION OF DRAWINGS

FIG. 1 is a configuration view of a vehicle braking device according to the present embodiment.

FIG. 2 is a conceptual diagram for explaining a switching position of a piston of the present embodiment.

FIG. 3 is a configuration view of an actuator according to the present embodiment.

FIG. 4 is a flowchart showing a flow of control of a first specific example of the present embodiment.

FIG. 5 is a conceptual diagram showing a change in hydraulic pressure in the first specific example of the present embodiment.

FIG. 6 is a flowchart showing a flow of control of a second specific example of the present embodiment.

FIG. 7 is a conceptual diagram showing a change in hydraulic pressure in a second specific example of the present embodiment.

FIG. 8 is a configuration view of a modified example of the present embodiment.

### DESCRIPTION OF EMBODIMENTS

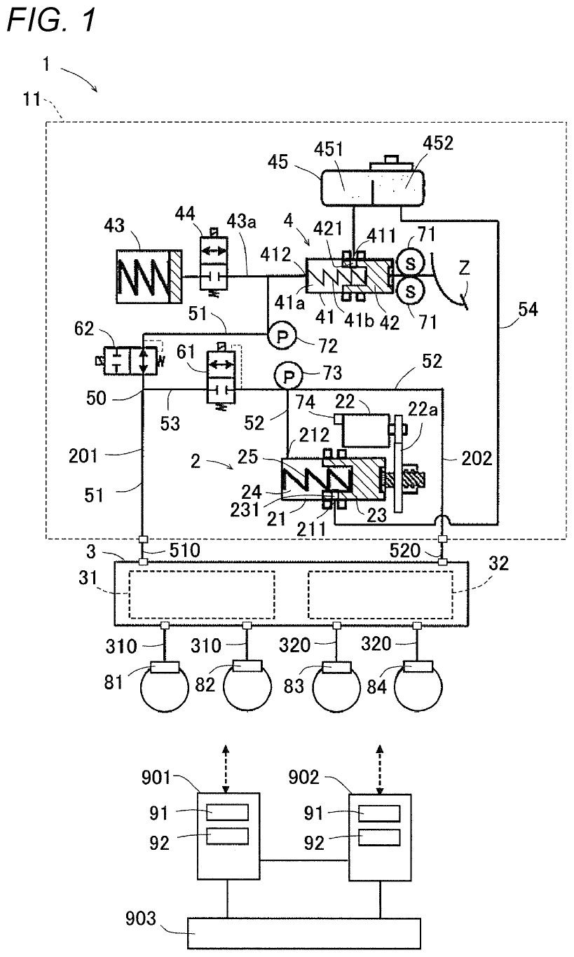

Hereinafter, embodiments of the present disclosure will be described based on the drawings. Each drawing used for description is a conceptual diagram. As illustrated in FIG. 1, a vehicle braking device 1 of the present embodiment includes an upstream unit 11, an actuator 3 constituting a downstream unit, a first brake ECU 901, a second brake ECU 902, and a power supply device 903. The upstream unit 11 is configured to be able to supply base hydraulic pressure to the downstream unit.

The upstream unit 11 includes an electric cylinder (corresponds to “first pressurizing unit”) 2, a master cylinder unit 4, a reservoir 45, a first liquid passage 51, a second liquid passage 52, a communication path 53, a brake fluid supply path 54, a communication control valve 61, and a master cut valve 62. The first brake ECU 901 controls at least the upstream unit 11. The second brake ECU 902 controls at least the actuator 3. Note that FIG. 1 illustrates a non-energized state of the vehicle braking device 1.

### (Electric Cylinder)

The electric cylinder 2 is a pressurizing unit (pressure adjusting unit) that is connected to the reservoir 45, and capable of pressurizing the wheel cylinders 81, 82, 83 and 84. The wheel cylinders 81 and 82 are first-system wheel cylinders, and the wheel cylinders 83 and 84 are second-system wheel cylinders. The piping connection is, for example, a front-rear piping in which the first system is disposed with respect to the front wheel and the second system is disposed with respect to the rear wheel. The piping connection may be a cross piping in which the front wheel and the rear wheel are disposed in each of the first system and the second system.

The electric cylinder 2 includes a cylinder 21, an electric motor 22, a piston 23, an output chamber 24, and a biasing member 25. The electric motor 22 is connected to the piston 23 by way of a linear motion mechanism 22a that converts rotational motion into linear motion. The electric cylinder 2 is a single type electric cylinder in which a single output chamber 24 is formed in the cylinder 21.

The piston 23 slides in an axial direction in the cylinder 21 by driving of the electric motor 22. The piston 23 is formed in a bottomed cylindrical shape that is opened on one side in the axial direction and has a bottom surface on the other side in the axial direction. That is, the piston 23 includes a tubular portion forming an opening and a columnar portion forming a bottom surface (pressure receiving surface).

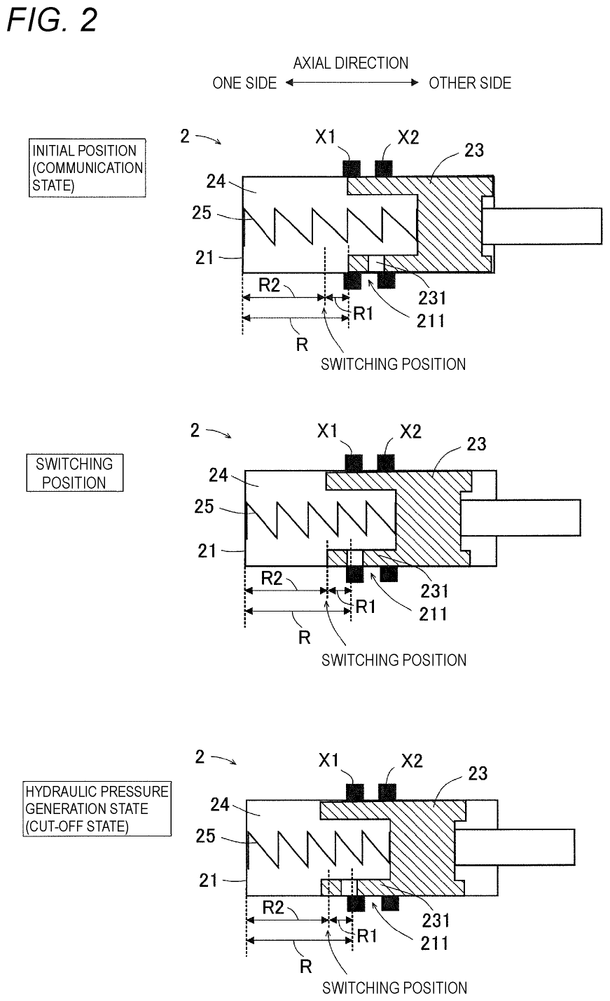

The output chamber 24 is partitioned by the cylinder 21 and the piston 23, and the volume changes by the movement of the piston 23. The output chamber 24 is connected to a reservoir 45 and the actuator 3. As illustrated in FIG. 2, the piston 23 slides in a sliding region R including a position where the volume of the output chamber 24 is minimized and a position where the volume of the output chamber 24 is maximized in the axial direction. The sliding region R includes a communication region R1 that communicates the output chamber 24 and the reservoir 45 with each other, and a cut-off region R2 that cuts off the output chamber 24 and the reservoir 45 from each other. The communication region R1 includes an initial position of the piston 23 where the volume of the output chamber 24 is maximized. The cut-off region R2 includes a position of the piston 23 where the volume of the output chamber 24 is minimized. The cut-off region R2 is larger than the communication region R1 in the axial direction. Note that in FIG. 2, each of the regions R, R1, and R2 is represented based on the position of one end (distal end) in the axial direction of the piston 23.

More specifically, an input port 211 and an output port 212 are formed in the cylinder 21. The output port 212 communicates the output chamber 24 and the second liquid passage 52. The input port 211 overlaps the tubular portion of the piston 23 when the piston 23 is located at the initial position. A through hole 231 is formed in the tubular portion of the piston 23. The through hole 231 is formed at a position (overlapping position) facing the input port 211 when the piston 23 is at the initial position.

In a state where the input port 211 and the through hole 231 are overlapped, the output chamber 24 and the reservoir 45 communicate with each other. As the piston 23 moves to one side in the axial direction, the width in which the input port 211 and the through hole 231 overlap decreases. In a state where the input port 211 and the through hole 231 do not overlap, the output chamber 24 and the reservoir 45 are cut off from each other.

The cylinder 21 is provided with seal members X1 and X2 (see FIG. 2). The input port 211 is formed between the seal member X1 and the seal member X2. The seal member X1 is an annular cup seal. Therefore, the seal member X1 prohibits the flow of the fluid from the output chamber 24 to the reservoir 45 and permits the flow of the fluid from the reservoir 45 to the output chamber 24 in a state (cut-off state) where the reference position of the piston 23 is in the cut-off region R2.

The communication region R1 becomes larger as the overlap distance (the axial width of the through hole 231 and/or the input port 211) becomes larger. In the present embodiment, the input port 211 and the through hole 231 have the same level of axial width. In the movement of the piston 23 to one side in the axial direction, the communication region R1 continues until the piston 23 moves from the initial position by a predetermined amount (overlap distance). The predetermined amount corresponds to a separation distance between the initial position and the switching position. The biasing member 25 is a spring disposed in the output chamber 24 and configured to bias the piston 23 toward the other side in the axial direction (toward the initial position).

The communication region R1 is a region between the initial position and the switching position of the piston 23. As shown in FIG. 2, when the piston moves from the initial position to one side in the axial direction and reaches the switching position, the overlap between the through hole 231 and the input port 211 is eliminated, and the connection state between the output chamber 24 and the reservoir 45 is switched from the communication state to the cut-off state. That is, it can be said that the electric cylinder 2 is in a hydraulic pressure generation state in which hydraulic pressure is generated in the output chamber 24. On the other hand, when the piston 23 moves to the other side in the axial direction and reaches the switching position in the cut-off state (hydraulic pressure generation state), the through hole 231 and the input port 211 start to overlap with each other, and the connection state is switched from the cut-off state to the communication state.

### <Actuator>

The actuator 3 is a pressure adjusting unit (downstream unit) including a first hydraulic pressure output unit 31 configured to be able to adjust the pressures of the wheel cylinders 81 and 82 and a second hydraulic pressure output unit 32 configured to be able to adjust the pressures of the wheel cylinders 83 and 84. The actuator 3 is connected to the electric cylinder 2. The first hydraulic pressure output unit 31 is configured to pressurize the wheel cylinders 81 and 82 by generating a differential pressure between the input hydraulic pressure and the hydraulic pressure of the wheel cylinders 81 and 82. Similarly, the second hydraulic pressure output unit 32 is configured to pressurize the wheel cylinders 83 and 84 by generating a differential pressure between the input hydraulic pressure and the hydraulic pressure of the wheel cylinders 83 and 84.

The actuator 3 is a so-called ESC actuator, and can independently adjust the hydraulic pressure of each wheel cylinder 81 to 84. The actuator 3 executes, for example, anti-skid control (also referred to as ABS control), side slip prevention control (ESC), traction control, or the like according to the control of the second brake ECU 902. The first hydraulic pressure output unit 31 and the second hydraulic pressure output unit 32 are independent of each other on the hydraulic pressure circuit of the actuator 3. The configuration of the actuator 3 will be described later.

### (Master Cylinder Unit)

The master cylinder unit 4 is a unit connected to the reservoir 45, and configured to mechanically supply brake fluid to the first hydraulic pressure output unit 31 of the actuator 3 according to the operation amount (stroke and/or depression force) of a brake operation member Z. The master cylinder unit 4 and the electric cylinder 2 can generate hydraulic pressure independently of each other. The master cylinder unit 4 is configured to be able to pressurize the wheel cylinders 81 and 82 through the first hydraulic pressure output unit 31. The master cylinder unit 4 includes a master cylinder 41 and a master piston 42.

The master cylinder 41 is a bottomed cylindrical member. An input port 411 and an output port 412 are formed in the master cylinder 41. The master piston 42 is a piston member that slides in the master cylinder 41 according to the operation amount of the brake operation member Z. The master piston 42 is formed in a bottomed cylindrical shape that is opened on one side in the axial direction and has a bottom surface on the other side in the axial direction.

In the master cylinder 41, a single master chamber 41a is formed by the master piston 42. In other words, in the master cylinder 41, a master chamber 41a is formed by the master cylinder 41 and the master piston 42. The volume of the master chamber 41a changes by the movement of the master piston 42. When the master piston 42 moves to one side in the axial direction, the volume of the master chamber 41a decreases, and the hydraulic pressure (hereinafter referred to as “master pressure”) in the master chamber 41a increases. The master chamber 41a is provided with a biasing member 41b that biases the master piston 42 toward the initial position (toward the other side in the axial direction). The master cylinder unit 4 of the present embodiment is a single type master cylinder unit.

The output port 412 communicates the master chamber 41a and the first liquid passage 51. The input port 411 communicates the master chamber 41a and the reservoir 45 with each other through a through hole 421 formed in a tubular portion of the master piston 42. At the initial position of the piston 42 at where the volume of the master chamber 41a is maximized, the input port 411 and the through hole 421 overlap, and the master chamber 41a and the reservoir 45 communicate with each other. When the master piston 42 moves from the initial position to one side in the axial direction by a predetermined amount (overlap distance), the connection between the master chamber 41a and the reservoir 45 is cut off.

A stroke simulator 43 and a simulator cut valve 44 are connected to the master cylinder unit 4. The stroke simulator 43 is a device that generates a reaction force (load) with respect to the operation of the brake operation member Z. When the brake operation is released, the master piston 42 is returned to the initial position by the biasing member 41b. The stroke simulator 43 includes, for example, a cylinder, a piston, and a biasing member. The stroke simulator 43 and the output port 412 of the master cylinder 41 are connected by a liquid passage 43a. The simulator cut valve 44 is a normally closed electromagnetic valve provided in the liquid passage 43a.

### (Liquid Passage and Electromagnetic Valve)

The first liquid passage 51 connects the master chamber 41a and the first hydraulic pressure output unit 31. The second liquid passage 52 connects the electric cylinder 2 and the second hydraulic pressure output unit 32. The communication path 53 connects the first liquid passage 51 and the second liquid passage 52.

The communication control valve 61 is a normally closed electromagnetic valve provided in the communication path 53. The communication control valve 61 permits or prohibits the supply of brake fluid to the first hydraulic pressure output unit 31 by the electric cylinder 2. In the communication control valve 61, a valve body is disposed closer to the wheel cylinders 81 and 82 side (first system side) than a valve seat to prevent backflow of the brake fluid from the wheel cylinders 81 and 82 to the electric cylinder 2 when the valve is closed. As a result, even if the hydraulic pressure of the wheel cylinders 81 and 82 becomes higher than the output hydraulic pressure of the electric cylinder 2 when the communication control valve 61 is closed, a force is applied to the valve body in a direction of being pressed against the valve seat (self-sealing), so that the valve is kept closed.

The master cut valve 62 is a normally open type electromagnetic valve provided between a connecting portion 50 of the first liquid passage 51 and the communication path 53 in the first liquid passage 51 and the master cylinder 41. The master cut valve 62 permits or prohibits the supply of brake fluid from the master cylinder unit 4 to the first hydraulic pressure output unit 31.

The brake fluid supply path 54 connects the reservoir 45 and the input port 211 of the electric cylinder 2. Note that the reservoir 45 stores brake fluid, and the internal pressure is maintained at atmospheric pressure. Furthermore, the inside of the reservoir 45 is partitioned into two rooms 451 and 452, in each of which the brake fluid is stored. The master cylinder unit 4 is connected to one room 451 of the reservoir 45, and the electric cylinder 2 is connected to the other room 452 by way of the brake fluid supply path 54. The reservoir 45 may be configured by two separate reservoirs rather than two rooms.

### (Summary of Configuration)

The electric cylinder 2 includes a cylinder 21, a piston 23 slidable in the cylinder 21, an electric motor 22 that drives the piston 23, and an output chamber 24 that is partitioned by the cylinder 21 and the piston 23 and whose volume changes by the movement of the piston 23, and is configured to be able to pressurize fluid by decreasing the volume of the output chamber 24 by the movement of the piston 23. The vehicle braking device 1 includes the electric cylinder 2 and the reservoir 45 connected to the output chamber 24, and is configured such that the connection state between the output chamber 24 and the reservoir 45 is switched between the communication state and the cut-off state according to the position of the piston 23.

### Configuration Example of Actuator

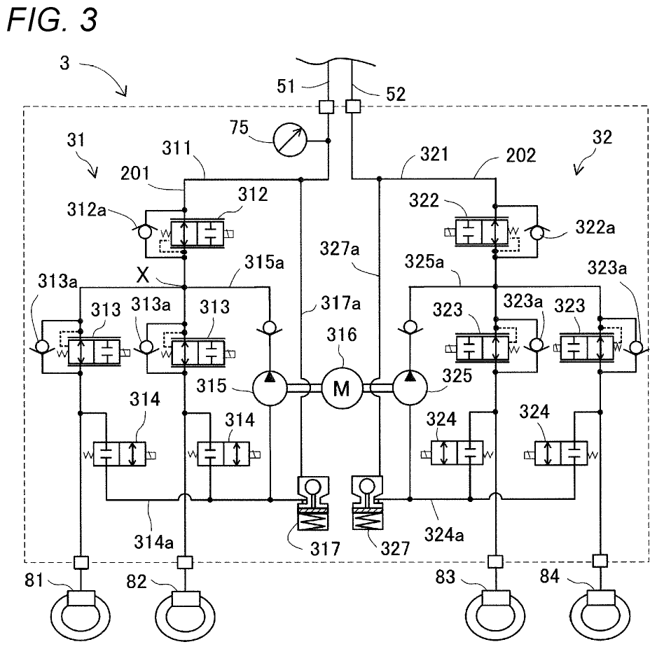

A configuration example of the actuator 3 will be briefly described using a liquid passage connected to the wheel cylinder 81 by way of an example. As illustrated in FIG. 3, the first hydraulic pressure output unit 31 of the actuator 3 mainly includes a liquid passage 311, a differential pressure control valve 312, a holding valve (corresponds to “electromagnetic valve”) 313, a pressure reducing valve 314, a pump 315, an electric motor 316, and a reservoir 317.

The liquid passage 311 connects the first liquid passage 51 and the wheel cylinder 81. A pressure sensor 75 is installed in the liquid passage 311. The differential pressure control valve 312 is a normally open type linear solenoid valve. A differential pressure can be generated between the upstream and downstream flows by controlling the opening degree of the differential pressure control valve 312 (force toward the valve closing side by the electromagnetic force). A check valve 312a that permits only the flow of the brake fluid from the first liquid passage 51 to the wheel cylinder 81 is provided in parallel with the differential pressure control valve 312.

The holding valve 313 is a normally open type electromagnetic valve provided between the differential pressure control valve 312 and the wheel cylinder 81 in the liquid passage 311. Furthermore, the check valve 313a is provided in parallel with the holding valve 313. The pressure reducing valve 314 is a normally closed electromagnetic valve provided in the pressure reducing liquid passage 314a. The pressure reducing liquid passage 314a connects a portion of the liquid passage 311 between the holding valve 313 and the wheel cylinder 81 and the reservoir 317.

The pump 315 is operated by the driving force of the electric motor 316. The pump 315 is provided in a pump liquid passage 315a. The pump liquid passage 315a connects a portion of the liquid passage 311 between the differential pressure control valve 312 and the holding valve 313 (hereinafter referred to as “branch portion X”) and the reservoir 317. When the pump 315 is operated, the brake fluid in the reservoir 317 is discharged to the branch portion X.

The reservoir 317 is a pressure adjusting reservoir. A reflux liquid passage 317a connects the first liquid passage 51 and the reservoir 317. The reservoir 317 is configured such that the brake fluid in the reservoir 317 is preferentially sucked by the operation of the pump 315, the valve is opened when the brake fluid in the reservoir 317 decreases, and the brake fluid is sucked from the first liquid passage 51 through the reflux liquid passage 317a.

When the wheel cylinder 81 is pressurized by the actuator 3, the second brake ECU 902 applies a control current corresponding to the target differential pressure (hydraulic pressure of the wheel cylinder 81>hydraulic pressure of the first liquid passage 51) to the differential pressure control valve 312, and closes the differential pressure control valve 312. At this time, the holding valve 313 is opened, and the pressure reducing valve 314 is closed. When the pump 315 is operated, the brake fluid is supplied from the first liquid passage 51 to the branch portion X through the reservoir 317. As a result, the wheel cylinder 81 is pressurized.

When the difference between the hydraulic pressure of the wheel cylinder 81 (hereinafter referred to as “first wheel pressure”) and the hydraulic pressure of the first liquid passage 51 attempts to increase above the target differential pressure, the differential pressure control valve 312 is opened from the magnitude relationship of the force. The first wheel pressure after pressurization is the sum of the hydraulic pressure in the first liquid passage 51 and the target differential pressure. In this manner, the actuator 3 pressurizes the wheel cylinder 81 by generating a differential pressure between the output hydraulic pressure of the electric cylinder 2 and the first wheel pressure. The same applies to pressurization of the other wheel cylinders 82, 83, and 84.

When the first wheel pressure is reduced by the actuator 3 through the anti-skid control or the like, the second brake ECU 902 operates the pump 315 in a state where the pressure reducing valve 314 is opened and the holding valve 313 is closed to pump back the brake fluid in the wheel cylinder 81. When the first wheel pressure is held by the actuator 3, the second brake ECU 902 closes the holding valve 313 and the pressure reducing valve 314. When the first wheel pressure is pressurized or depressurized only by the operation of the electric cylinder 2 or the master cylinder unit 4, the second brake ECU 902 opens the differential pressure control valve 312 and the holding valve 313 and closes the pressure reducing valve 314.

Since the configuration of the second hydraulic pressure output unit 32 is the same as that of the first hydraulic pressure output unit 31, the description thereof will be omitted. The liquid passage 321 of the second hydraulic pressure output unit 32 corresponding to the liquid passage 311 of the first hydraulic pressure output unit 31 connects the second liquid passage 52 and the wheel cylinders 83 and 84. As described above, the second hydraulic pressure output unit 32 includes the liquid passage 321 corresponding to the liquid passage 311, the differential pressure control valve 322 corresponding to the differential pressure control valve 312, the holding valve 323 corresponding to the holding valve 313, the pressure reducing valve 324 corresponding to the pressure reducing valve 314, the pump 325 corresponding to the pump 315, and the reservoir 327 corresponding to the reservoir 317. The actuator 3 is configured to be able to pressurize the wheel cylinders 81 to 84 independently of the electric cylinder 2. In the following description, the hydraulic pressure of the wheel cylinders 81 to 84 is also referred to as a wheel pressure.

### (Brake ECU and Various Sensors)

The first brake ECU 901 and the second brake ECU 902 (hereinafter, also referred to as “Brake ECUs 901, 902”) are electronic control units each including a CPU and a memory. Each of the brake ECUs 901 and 902 includes one or a plurality of processors that execute various processes (controls). The first brake ECU 901 and the second brake ECU 902 are separate ECUs, and are connected to each other so as to be able to communicate information (control information etc.).

The first brake ECU 901 is controllably connected to the electric cylinder 2 and the electromagnetic valves 61, 62, and 44. The second brake ECU 902 is controllably connected to the actuator 3. Each of the brake ECUs 901 and 902 execute various controls based on detection results of the various sensors. As various sensors, the vehicle braking device 1 is provided with, for example, a stroke sensor 71, pressure sensors 72, 73, and 75, a rotation angle sensor 74, a wheel speed sensor (not illustrated), a yaw rate sensor (not illustrated), an acceleration sensor (not illustrated), and the like.

The stroke sensor 71 detects a stroke of the brake operation member Z. The vehicle braking device 1 is provided with two stroke sensors 71 so as to correspond to the brake ECUs 901 and 902 on a one-to-one basis. The brake ECUs 901 and 902 acquire stroke information from the corresponding stroke sensors 71, respectively. The pressure sensor 72 is a sensor that detects the master pressure, and is provided, for example, in a portion of the first liquid passage 51 closer to the master cylinder 41 side than the master cut valve 62. The pressure sensor 73 is a sensor that detects the output hydraulic pressure of the electric cylinder 2, that is, the pressure of the output chamber 24, and is provided, for example, in the second liquid passage 52. The rotation angle sensor 74 is provided with respect to the electric motor 22 of the electric cylinder 2, and detects a rotation angle (rotation position) of the electric motor 22. The pressure sensor 75 detects an input hydraulic pressure from the first liquid passage 51 to the first hydraulic pressure output unit 31. Detection values of the various sensors may be transmitted to both brake ECUs 901 and 902.

The first brake ECU 901 receives the detection results of the stroke sensor 71, the pressure sensors 72 and 73, and the rotation angle sensor 74, and controls the electric cylinder 2 and the electromagnetic valves 61, 62, and 44 based on the detection results. The first brake ECU 901 can calculate each wheel pressure based on the detection results of the pressure sensors 72 and 73 and the control state of the actuator 3.

The second brake ECU 902 receives the detection results of the stroke sensor 71 and the pressure sensor 75, and controls the actuator 3 based on the detection results. The second brake ECU 902 can calculate each wheel pressure based on the control states of the pressure sensor 75 and the actuator 3. The second brake ECU 902 sets a first target differential pressure, which is a target value of the first differential pressure (differential pressure between input pressure and hydraulic pressure of wheel cylinders 81, 82), and a second target differential pressure, which is a target value of the second differential pressure (differential pressure between the input pressure and the hydraulic pressure of the wheel cylinders 83, 84).

The power supply device 903 is a device that supplies power to the brake ECUs 901 and 902. The power supply device 903 includes a battery. The power supply device 903 is connected to both the brake ECUs 901 and 902. That is, in the present embodiment, power is supplied from the power supply device 903 common to the two brake ECUs 901 and 902.

### (Position Estimation Process)

The first brake ECU 901 includes an estimation unit 91 that executes a position estimation process. The position estimation process is a process of moving the piston 23 and estimating the switching position of the piston 23 at which the connection state between the output chamber 24 and the reservoir 45 is switched based on the detection value of the pressure sensor 73.

The estimation unit 91 executes the position estimation process at a predetermined timing. In the position estimation process, the estimation unit 91 moves the piston 23 to one side in the axial direction from the initial position, and stores the detection value of the rotation angle sensor 74 when the detection value of the pressure sensor 73 becomes larger than or equal to the threshold value as the switching position (pressurizing switching position). In addition, the estimation unit 91 moves the piston 23 to the other side in the axial direction with respect to the electric cylinder 2 in the hydraulic pressure generation state by the position estimation process, and stores the detection value of the rotation angle sensor 74 when the pressure sensor 73 becomes less than or equal to the threshold value as the switching position (pressure reduction switching position). The estimation unit 91 may store at least one of the pressurizing switching position and the pressure reduction switching position in the position estimation process. The estimation unit 91 may correct the switching position information based on the moving direction of the piston 23.

The position estimation process is executed, for example, when the vehicle is stopped and can be kept stopped even if there is no wheel pressure (e.g., when the EPB is in operation or when the shift lever is in the P range) or when the vehicle is traveling (when the brake operation is not performed).

### (Effect of Position Estimation Process)

According to the present embodiment, when the output chamber 24 and the reservoir 45 are in the communication state, no hydraulic pressure is generated in the output chamber 24 even if the piston 23 is moved. On the other hand, when the output chamber 24 and the reservoir 45 are in the cut-off state, the hydraulic pressure in the output chamber 24 changes according to the movement of the piston 23. At the time of pressurization, the detection value of the pressure sensor 73 starts to rise from 0 (hydraulic pressure of the reservoir 45) when going beyond the switching position. At the time of pressure reduction, the detection value of the pressure sensor 73 becomes 0 when going beyond the switching position.

In the position estimation process, the estimation unit 91 can estimate the switching position of the piston by monitoring the detection value of the pressure sensor 73 while moving the piston 23 and detecting the hydraulic pressure change (change with respect to 0) of the output chamber 24 as described above. Since the switching position of the piston 23 is estimated based on the actual hydraulic pressure change, the switching position corresponding to the vehicle situation at the time of executing the position estimation process can be acquired. The estimation unit 91 stores, for example, information (rotation angle information) on the rotation position of the electric motor 22 as information on the switching position. For example, the position of the piston 23 can be calculated from the rotation position of the electric motor 22 and the gear ratio of the linear motion mechanism 22a. Thus, according to the present embodiment, the switching position of the piston 23 at which the connection state between the output chamber 24 of the electric cylinder 2 and the reservoir 45 is switched can be accurately estimated.

### (Rigidity Changing Process)

The second brake ECU 902 includes a rigidity changing unit 92. When the position estimation process is executed by the estimation unit 91, the rigidity changing unit 92 executes a rigidity changing process for increasing the rigidity of the output chamber 24. The rigidity of the output chamber 24 is a hydraulic pressure change amount when the output chamber 24 is changed by a unit volume. The rigidity of the output chamber 24 can also be said to be an amount of hydraulic pressure that increases when the output chamber 24 is reduced by a unit volume. The higher the rigidity of the output chamber 24, the larger the amount of hydraulic pressure that increases when the output chamber 24 is reduced by a unit volume.

The rigidity of the output chamber 24 is affected by the volumes of the output liquid passages 201 and 202 connecting the output chamber 24 and the wheel cylinders 81 to 84 and the rigidity of the wheel cylinders 81 to 84. Examples of a case where the rigidity of the output chamber 24 increases include, for example, a case where the rigidity of the wheel cylinder 81 to 84 increases, and a case where the volumes of the output liquid passages 201 and 202 decrease.

The output liquid passage 201 is configured by a part of the second liquid passage 52, the communication path 53, a part of the first liquid passage 51, and the liquid passage 311. The output liquid passage 202 includes a second liquid passage 52 and a liquid passage 321. The rigidity of the wheel cylinder 81 to 84 is lower than the rigidity of the output liquid passages 201 and 202 when the wheel pressure is a value in the initial region (0≤wheel pressure≤predetermined pressure). Therefore, in the low pressure region, the rigidity of the output chamber 24 is affected by the rigidity of the wheel cylinder 81 to 84. The rigidity (hydraulic pressure change amount/volume change amount) of the wheel cylinder 81 to 84 changes according to the wheel pressure.

### First Specific Example of Rigidity Changing Process

As a first specific example of the rigidity changing process, the rigidity changing unit 92 pressurizes the wheel cylinders 81 to 84 by the actuator 3. The rigidity changing unit 92 controls the actuator 3 to supply fluid to the wheel cylinders 81 to 84 before the estimation unit 91 executes the position estimation process. The pressurization of the wheel cylinder 81 to 84 by the actuator 3 is executed by supplying the control current to the differential pressure control valves 312 and 322 and operating the pumps 315 and 325, as described above. As a result, the wheel pressure increases, the rigidity of the wheel cylinders 81 to 84 increases, and the rigidity of the output chamber 24 also increases.

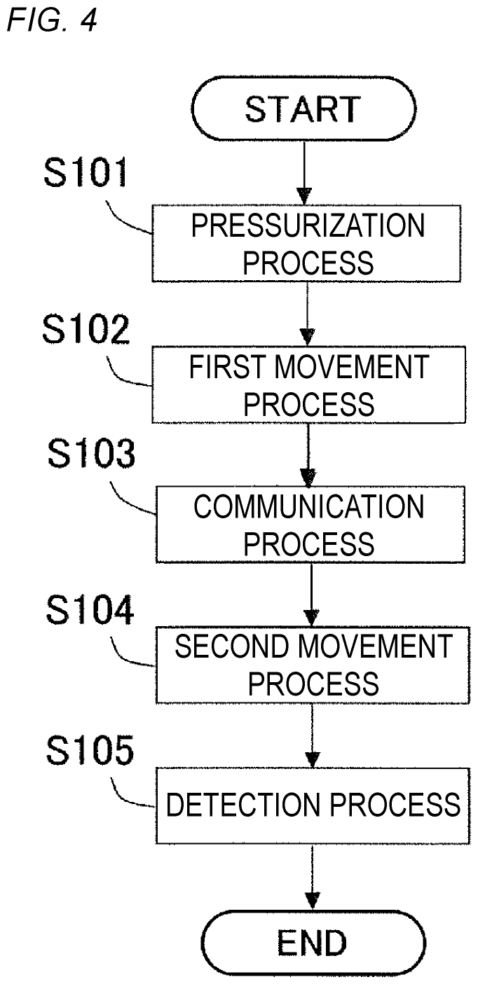

More specifically, as illustrated in FIG. 4, the brake ECUs 901 and 902 execute a pressurization process S101, a first movement process S102, a communication process S103, a second movement process S104, and a detection process S105. First, when the rigidity changing process is executed, the differential pressure control valves 312 and 322 are closed according to the target differential pressure, and the wheel cylinders 81 to 84 are pressurized by the operations of the pumps 315 and 325 (S101).

The hydraulic pressure increase amount (increase gradient) of the output chamber 24 with respect to the volume decrease amount of the output chamber 24 is steeper than that before the execution of the pressurization process S101. That is, the rigidity of the output chamber 24 increases.

After the differential pressure between the upstream and downstream flows of the differential pressure control valves 312 and 322 reaches the target differential pressure (after completion of the pressurization process S101), the estimation unit 91 drives the electric motor 22 to move the piston 23 of the electric cylinder 2 to one side in the axial direction from the initial position (S102). When the piston 23 moves through the communication region R1 and enters the cut-off region R2 beyond the switching position, the hydraulic pressure in the output chamber 24 rises, and the hydraulic pressure obtained by adding the target differential pressure of the differential pressure control valves 312 and 322 to the hydraulic pressure in the output chamber 24 is generated in the wheel cylinders 81 to 84. Note that the estimation unit 91 may store the rotation position of the electric motor 22 when the detection value of the pressure sensor 73 (hydraulic pressure of the output chamber 24) exceeds the threshold value, but in the present example, stores the switching position detected at the time of pressure reduction.

In the first movement process S102, the estimation unit 91 moves the piston 23 by a predetermined amount and stops it. In other words, the estimation unit 91 stops the piston 23 when the wheel pressure reaches the target wheel pressure. The rigidity changing unit 92 stops the pumps 315 and 325, stops the supply of the control current to the differential pressure control valves 312 and 322, and opens the differential pressure control valves 312 and 322 (target differential pressure=0) (S103). As a result, the relatively high-pressure wheel cylinders 81 to 84 communicates with the relatively low-pressure output chamber 24, and the fluid flows into the output chamber 24. The hydraulic pressure in the output chamber 24 rises due to the inflow of the fluid, and the piston 23 is pushed back to the other side in the axial direction due to the rise in the hydraulic pressure. In the output chamber 24, a hydraulic pressure corresponding to the wheel pressure, that is, a hydraulic pressure lifted by the actuator 3 is generated.

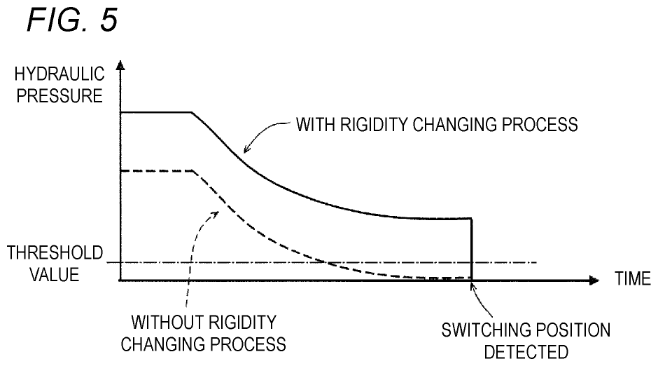

The estimation unit 91 lowers the output (torque) of the electric motor 22 in a state where the hydraulic pressure is lifted, and moves the piston 23 to the other side in the axial direction (S104). As a result, as illustrated in FIG. 5, the lifted hydraulic pressure of the output chamber 24 gradually decreases. Then, when the connection state between the output chamber 24 and the reservoir 45 is switched from the cut-off state to the communication state, the output chamber 24 communicates with the reservoir 45 at atmospheric pressure, and the fluid flows out to the reservoir 45 at a high flow rate. As a result, the lifted hydraulic pressure of the output chamber 24 decreases to 0 at once, and the detection value of the pressure sensor 73 falls below the threshold value for detecting (determining) the switching position.

The estimation unit 91 detects when the detection value of the pressure sensor 73 becomes a threshold value (less than or equal to the threshold value), and stores the detection value of the rotation angle sensor 74 at that time (S105). That is, the estimation unit 91 stores the rotation position of the electric motor 22 corresponding to the position of the piston 23 when the detection value of the pressure sensor 73 becomes the threshold value. When the detection value of the pressure sensor 73 becomes the threshold value, the estimation unit 91 estimates that the piston 23 is located at the switching position, and stores information on that position.

As described above, the position estimation process of the first specific example includes the first movement process S102 of moving the piston 23 to one side in the axial direction, the second movement process S104 of moving the piston 23 to the other side in the axial direction after the first movement process S102, and the detection process S105 of detecting the switching position based on the detection value of the pressure sensor 73 during the second movement process. In addition, the rigidity changing unit 92 pressurizes the wheel cylinders 81 to 84 by the actuator 3 in a state where the wheel cylinders 81 to 84 and the output chamber 24 are cut off before the first movement process S102 (pressurization process S101), and communicates the wheel cylinders 81 to 84 and the output chamber 24 with each other before the second movement process S104 (communication process S103). The hydraulic pressure corresponding to the wheel pressure is generated in the output chamber 24 by executing the communication process S103. The pressurization process S101 and the communication process S103 can also be said to be a lifting process of lifting the hydraulic pressure of the output chamber 24 before the second movement process S104.

### Effects of First Specific Example

According to the first specific example, the wheel cylinders 81 to 84 are pressurized by the pressurization process S101. Thereafter, the connection state between the output chamber 24 and the reservoir 45 is cut off by the first movement process S102. When the connection state between the wheel cylinder 81 to 84 and the output chamber 24 is switched from the cut-off state to the communication state by the communication process S103, the hydraulic pressure of the output chamber 24 is lifted, and the hydraulic pressure of the output chamber 24 immediately before the piston 23 moves to the other side in the axial direction and reaches the switching position becomes a combined characteristic of the pressurization by the electric cylinder 2 and the pressurization by the actuator 3. Therefore, until the piston actually reaches the switching position and the output chamber 24 communicates with the reservoir 45, the liquid amount on the wheel cylinder 81 to 84 side is increased with respect to the master cut valve 62 by the pressurization process S101, and thus, the detection value of the pressure sensor 73 does not become less than or equal to the threshold value, and the detection value becomes less than or equal to the threshold value only after the output chamber 24 and the reservoir 45 communicate with each other. The hydraulic pressure in the output chamber 24 and the wheel pressure reduce at once from a state of being lifted to 0 by the communication between the two. As a result, the switching position of the piston can be estimated more accurately.

The rigidity changing unit 92 preferably sets the target differential pressure (differential pressure with respect to the atmospheric pressure) of the differential pressure control valves 312 and 322 to a value higher than the threshold value in the pressurization process S101. This suppresses the hydraulic pressure in the output chamber 24 from becoming less than the threshold value until the piston 23 reaches the switching position. Note that, in the first specific example, in the first movement process S102, the detection value of the pressure sensor 73 (the hydraulic pressure of the output chamber 24) starts to rise from 0, and the position information at the timing the threshold value (greater than or equal to the threshold value) is reached may be stored. However, in the first specific example, the flow rate of the fluid is higher when the output chamber 24 and the reservoir 45 communicate with each other in the second movement process S104 than in the first movement process S102 (the change gradient of the hydraulic pressure is large). Therefore, when the rigidity changing process is the pressurization process S101, the switching position can be estimated more accurately by detecting the switching position at the time of the second movement process S104.

### Second Specific Example of Rigidity Changing Process

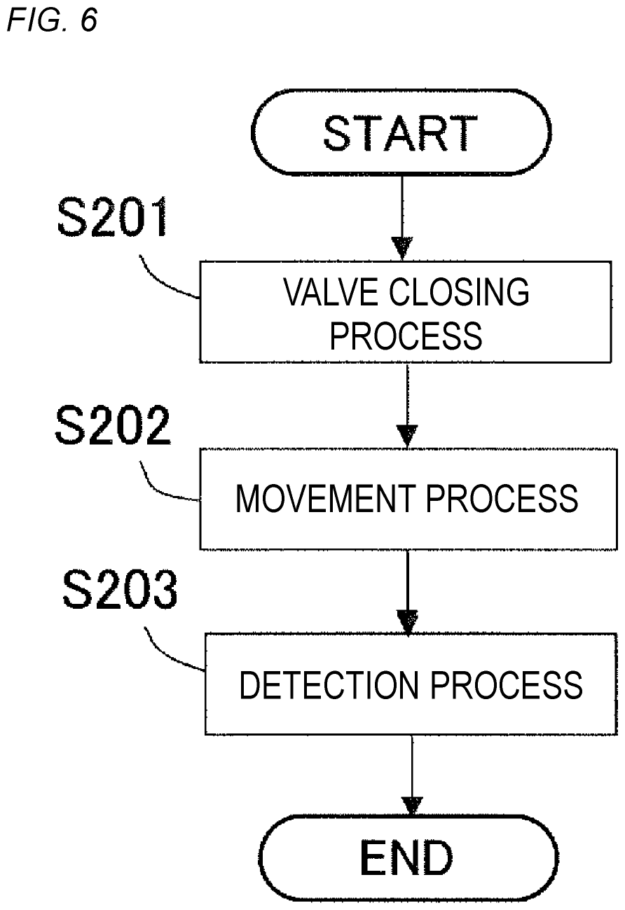

As a second specific example of the rigidity changing process, as illustrated in FIG. 6, the rigidity changing unit 92 closes the holding valves 313 and 323 (S201: valve closing process). As described above, the holding valves 313 and 323 are provided in the output liquid passages 201 and 202, and are configured to be able to hold the hydraulic pressure of the wheel cylinder 81 to 84 by closing the valves. By closing all the holding valves 313 and 323, the fluid flowing out from the electric cylinder 2 is cut off by the holding valves 313 and 323 before reaching the wheel cylinders 81 to 84. Note that the fluid flowing out from the electric cylinder 2 may be cut off by the communication control valve 61 instead of the holding valve 313.

Since the output chamber 24 and the wheel cylinders 81 to 84 are cut off by the valve closing process S201, the volumes of the output liquid passages 201 and 202 decrease. Thus, in the output chamber 24, the increase gradient of the hydraulic pressure when the unit volume decreases becomes large. That is, the rigidity of the output chamber 24 increases. In addition, since the output liquid passages 201 and 202 are cut off, the rigidity of the output chamber 24 is not affected by the rigidity of the wheel cylinders 81 to 84. Thus, the rigidity of the output chamber 24 is increased by the valve closing process S201.

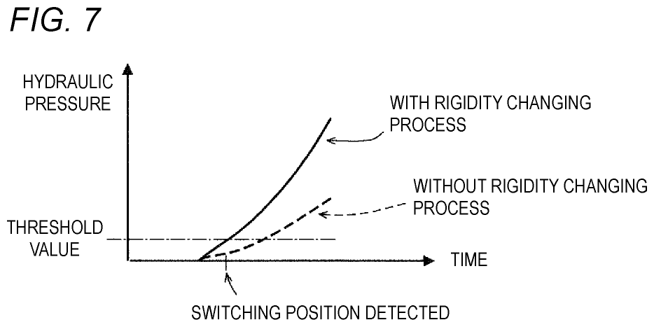

After the valve closing process S201, the estimation unit 91 moves the piston 23 to one side in the axial direction from the initial position (S202: movement process). Then, as illustrated in FIG. 7, the estimation unit 91 detects when the detection value of the pressure sensor 73 becomes a threshold value (greater than or equal to the threshold value), and stores the detection value of the rotation angle sensor 74 at that time (S203: detection process).

### Effect of Second Specific Example

According to the second specific example, since the rigidity of the output chamber 24 is increased by the valve closing process S201, the increase gradient of the detection value of the pressure sensor 73 increases when the piston 23 goes beyond the switching position by the movement process S202. Therefore, the detection value of the pressure sensor 73 becomes larger than or equal to the threshold value at an early timing after the piston 23 reaches the switching position. That is, the switching position can be detected more accurately.

When the rigidity changing process is the valve closing process S201, it can be estimated that there is not much difference between the detection at the time of pressurization and the detection at the time of depressurization or pressure reduction from the viewpoint of the detection accuracy of the switching position. Therefore, in the case of second specific example, it is preferable that the estimation unit 91 detect the switching position at the time of pressurization (at the time of the movement process S202) from the viewpoint of shortening the time of the position estimation process.

(Control after Position Estimation Process)

After the switching position is detected and stored by the position estimation process, the first brake ECU 901 moves the piston 23 from the initial position to the switching position at a predetermined timing (e.g., at the start of traveling of the vehicle). As a result, the invalid stroke becomes small or zero, and the responsiveness with respect to the generation of the braking force improves. In addition, the first brake ECU 901 may move the piston 23 to one side in the axial direction beyond the switching position so that the hydraulic pressure is generated in the output chamber 24 within a range in which no braking force is substantially generated at a predetermined timing. Accordingly, the invalid stroke can be more reliably set to 0. The reduction in responsiveness due to an invalid stroke and occurrence of dragging due to generation of unnecessary braking force can be suppressed by accurately acquiring the information of the switching position as in the present embodiment. According to the present embodiment, for example, the responsiveness of the collision damage reduction brake (AEB) improves. In addition, in a case where the switching position is detected at the time of pressurization, it is suitable to stop the movement of the piston 23 at the time point the switching position is reached and stop the piston at that position. As a result, for example, the process of moving the piston 23 to the switching position again becomes unnecessary.

### Modified Example

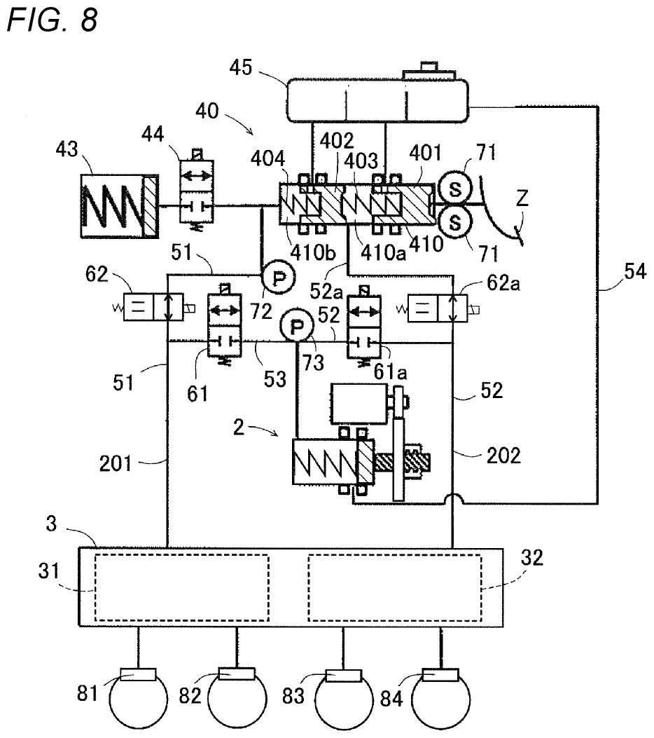

The present disclosure is not limited to the embodiment described above. For example, as a modified example of the master cylinder unit 4, as illustrated in FIG. 8, the master cylinder unit 40 may be a tandem type cylinder unit having two master chambers 410a and 410b. The master cylinder unit 40 includes a master cylinder 410, a first master piston 401, a second master piston 402, and biasing members 403 and 404.

In the master cylinder 410, a first master chamber 410a defined by the first master piston 401 and the second master piston 402 and a second master chamber 410b defined by the second master piston 402 are formed. The biasing member 403 is disposed in the first master chamber 410a and biases the first master piston 401 toward the initial position. The biasing member 404 is disposed in the second master chamber 410b and biases the second master piston 402 toward the initial position.

The master cylinder unit 40 is configured such that the first master chamber 410a and the second master chamber 410b have the same pressure. Communication between the reservoir 45 and the master chambers 410a and 410b is cut off when the master pistons 401 and 402 advance from the initial positions by a predetermined amount. The first master chamber 410a is connected to the second liquid passage 52 through the liquid passage 52a. A master cut valve 62a is disposed in the liquid passage 52a. A communication control valve 61a is disposed in a portion of the second liquid passage 52 between a connection point between the liquid passage 52a and the second liquid passage 52 and the output chamber 24. The configuration and function of each of the electromagnetic valves 61a and 62a are similar to those of the electromagnetic valves 61 and 62.

According to this configuration, when the master cut valves 62 and 62a are opened, the hydraulic pressure (master pressure) can be supplied from the master cylinder unit 40 to all the wheel cylinders 81 to 84. In this configuration, the pressurization process S101 may be executed by the operation of the master cylinder unit 40.

For example, in a stop state by a braking force other than the hydraulic pressure braking force, the rigidity changing unit 92 instructs the driver (or the inspection worker) to operate the brake operating member Z by, for example, voice or display screen before the position estimation process is executed. The state of the electromagnetic valve at this time is a non-energized state, where the master cut valves 62 and 62a are opened, the communication control valves 61 and 61a are closed, and the simulator cut valve 44 is closed.

When the driver depresses the brake operation member Z, the master pistons 401 and 402 move, and fluid is supplied from each of the master chambers 410a and 410b to the wheel cylinders 81 to 84. For example, when the driver operates the brake operation member Z by a predetermined stroke, the rigidity changing unit 92 presents an operation stop instruction to the driver. The rigidity changing unit 92 then, for example, closes the differential pressure control valves 312 and 322. Accordingly, the pressurization process S101 is completed. Thereafter, the estimation unit 91 and the rigidity changing unit 92 execute a control similar to the flow of FIG. 4. In this manner, the rigidity changing process may be executed by the master cylinder unit 40. In this case, the master cylinder unit 40 corresponds to the second pressurizing unit.

### Another Example of Execution Timing of Position Estimation Process

The estimation unit 91 and the rigidity changing unit 92 may execute the position estimation process and the pressurization process S101 when there is a high possibility that the caliper knock-back has occurred. The caliper knock-back is a phenomenon in which the brake pad is pushed by the rotor and the piston in the caliper is retracted when the vehicle turns. When the caliper knock-back occurs, an invalid stroke of the piston (a stroke in which the braking force is not generated) increases.

The brake ECUs 901 and 902 can detect (determine) a turning state and a straight advancing state of the vehicle based on, for example, detection values of a yaw rate sensor, a steering angle sensor, and the like. When the straight advancing state after the turning of the vehicle is detected, the rigidity changing unit 92 executes the pressurization process S101 for the position estimation process. Then, the estimation unit 91 executes the position estimation process, for example, as illustrated in FIG. 4.

According to this configuration, the piston in the caliper is pressed toward the brake pad by the pressurization process S101, and the invalid stroke becomes small. That is, according to this configuration, the position estimation process and the rigidity changing process can be used for canceling the caliper knock-back. Furthermore, the estimation unit 91 may execute the position estimation process according to the temperature change of the fluid. The pressure sensor 73 includes a temperature sensor and can detect the temperature of the fluid. For example, when the first brake ECU 901 moves the piston 23 to one side in the axial direction from the switching position in order to set the invalid stroke of the electric cylinder 2 to 0, the liquid passage between the electric cylinder 2 and the wheel cylinders 81 to 84 is in a sealed state. For example, if the temperature of the fluid increases in the sealed state, an increase in the fluid volume may generate pressure and apply load to the device (increase the load torque). Since the output chamber 24 and the reservoir 45 communicate with each other by executing the position estimation process at such timing, the load state due to the temperature change can be reset.

As described above, the position estimation process and the rigidity changing process are executed, for example, at the time of predetermined stop state in which the vehicle is stopped without hydraulic pressure braking force, at the time of vehicle traveling, at the time of the vehicle advancing straight after turning, or at the time when a temperature change is greater than or equal to a predetermined value. Although the braking force can be generated in the pressurization process S101, the position estimation process and the rigidity changing process can be executed in a short time (e.g., several hundred milliseconds), and hence even if the processes are performed during traveling, the driving feeling of the driver is hardly affected.

### (Others)

The present disclosure can also be applied to, for example, a vehicle (hybrid vehicle or electric vehicle) including a regenerative braking device, a vehicle that executes automatic brake control, or an automatic driving vehicle. The vehicle braking device may be controlled by one brake ECU.

1. A braking device for a vehicle comprising:
a reservoir;
a first pressurizing unit including a cylinder, a piston slidable in the cylinder, an electric motor that drives the piston, and an output chamber partitioned by the cylinder and the piston and in which volume changes by movement of the piston, the first pressurizing unit being configured such that a connection state between the output chamber and the reservoir is switched between a communication state and a cut-off state according to a position of the piston, and the first pressurizing unit being capable of pressurizing fluid by decreasing a volume of the output chamber by movement of the piston to one side in an axial direction;
a pressure sensor that detects a pressure of the output chamber; and
an estimation unit that executes a position estimation process of moving the piston and estimating a switching position of the piston at which the connection state of the output chamber and the reservoir is switched based on a detection value of the pressure sensor.

2. The braking device for the vehicle according to claim 1, further comprising a rigidity changing unit that executes a rigidity changing process of increasing rigidity of the output chamber when the position estimation process is executed by the estimation unit, wherein
the rigidity of the output chamber is a hydraulic pressure change amount when the output chamber is changed by a unit volume.

3. The braking device for the vehicle according to claim 2, further comprising:
a wheel cylinder connected to the output chamber; and
a second pressurizing unit capable of pressurizing the wheel cylinder, wherein
the rigidity changing unit pressurizes the wheel cylinder by the second pressurizing unit as the rigidity changing process.

4. The braking device for the vehicle according to claim 3, wherein
the position estimation process includes a first movement process of moving the piston to one side in the axial direction, a second movement process of moving the piston to the other side in the axial direction after the first movement process, and a detection process of detecting the switching position based on a detection value of the pressure sensor during the second movement process, and
the rigidity changing unit pressurizes the wheel cylinder by the second pressurizing unit in a state where the wheel cylinder and the output chamber are cut off before the first movement process, and causes the wheel cylinder and the output chamber to communicate with each other before the second movement process.

5. The braking device for the vehicle according to claim 2, further comprising:
an output liquid passage connecting the output chamber and the wheel cylinder; and
an electromagnetic valve provided in the output liquid passage and capable of holding a hydraulic pressure of the wheel cylinder by closing the valve, wherein
the rigidity changing unit closes the electromagnetic valve as the rigidity changing process.
